(19) United States
(12) Patent Application Publication
(10) Pub. No.: US 2016/0067142 A1
(43) Pub. Date: Mar. 10, 2016

(54) STORAGE OR INFUSION BOTTLE

(71) Applicant: WEST PHARMACEUTICAL SERVICES DEUTSCHLAND GMBH & CO. KG, Eschweiler (DE)

(72) Inventor: Bernd BECKER, Aachen (DE)

(21) Appl. No.: 14/784,109

(22) PCT Filed: Apr. 18, 2013
(86) PCT No.: PCT/EP2013/001149

§ 371 Date: Oct. 13, 2015

(51) Int. Cl. A61J 1/14

(52) U.S. Cl. CPC A61J 1/1406; A61J 1/1412; A61J 1/1431; A61J 1/1493

(57) ABSTRACT

The present invention relates to a storage or infusion bottle (1) with a bottle neck (3) moulded integrally thereon, the bottle neck having at least one teat-shaped bottle feature (4, 5) projecting from its mouth end, the closed teat end wall (6, 7) of said bottle feature being designed to be puncturable by an infusion needle. The storage or infusion bottle (1) according to the invention is characterized in that a cap (8) is attachable to the bottle neck (3), in that the cap (8) has at least one funnel-shaped cap feature (9, 10), its (9, 10) feature interior space accommodating at least the free end region of the corresponding bottle feature (4, 5), and in that the intermediate space between the end wall of the at least one bottle feature (4, 5) and the opposing side of the corresponding cap feature (9, 10) is completely filled by a hat-shaped sealing element (11, 12) which encloses the bottle feature (4, 5) at least in its end region facing away from the storage or infusion bottle (1) and which is held at the circumference of its hat shape in a form-fitting and/or force-fitting manner on the circumference of the bottle feature (4, 5).

The present invention relates to a storage or infusion bottle with a bottle neck moulded integrally thereon, the bottle neck having at least one teat-shaped bottle feature projecting from its mouth end, the closed teat end wall of said bottle feature being designed to be puncturable by an infusion needle.

Such storage or infusion bottles, which are mostly intended for a pharmaceutical fluid that has to be kept sterile, are also referred to as blow-fill-seal bottles, reflecting the process steps which are in immediate succession during a manufacturing process. In the case of these storage or infusion bottles, the fluid is filled into them immediately after the plastic bottle has been blown, in order to subsequently close this bottle as one piece also at the free mouth end of its bottle neck. In as far as a cap is attached to this storage or infusion bottle, such a cap primarily serves as an attachment point for the required infusion equipment. In preparation for an infusion, the cap, the end wall provided at the free end of the bottle neck, and the intermediate space remaining between this cap and the end wall need to be punctured by means of the infusion cannula in order for the fluid to be subsequently extractable, for instance drop by drop, from the bottle via this cannula.

Since a cap, which on its inside has a seal disc, made from a rubber-like material for the purpose of puncturing, is attached to the mouth end of the bottle neck of traditional blow-fill-seal bottles, and since an intermediate space remains between the mouth end of the bottle neck of the traditional blow-fill-seal bottles on the one hand and the cap attached to said mouth end on the other hand, a dead space is created in this intermediate space, into which dead space leaking fluid flows along the outside of the cannula during the extraction process, said fluid also not being subsequently extractable again from the dead space via the cannula. This not only leads to the sterile fluid not being fully usable—far rather, the dosing of any drug is complicated by the residual amount of leaked fluid remaining between mouth end of the bottle neck and cap.

From DE 44 25 433 C1 a storage bottle is already known which is designed to accommodate a medical fluid. The known storage bottle has a closure with a cap, a cup-shaped feature with a relatively small diameter projecting from the end wall of the cap. A separately produced, disc-shaped elastic sealing element is inserted from the inside of the cap into this cup-shaped feature, said sealing element having an annular flange on the circumference at its end facing away from the feature. Once the separately produced sealing element has simply been placed into the cup-shaped feature, the sealing element, by means of its annular flange, can be welded to the inside of the cap. However, when piercing the sealing element with an infusion needle there is the risk that, prior to puncturing the end wall closing the bottle neck, the needle tip initially deforms this end wall in such a way that a dead space is created between the bottle and the cap attached to it, resulting in the disadvantages mentioned above with regard to an insufficient emptying of the contents of the bottle and an incorrect dosing of the respective drug.

The problem addressed is thus that of providing a storage or infusion bottle of the aforementioned type which facilitates an at least substantially complete extraction of the fluid stored therein and thus also a correct dosing.

The solution according to the invention to this problem in the storage or infusion bottle of the type mentioned at the outset lies in particular in that a cap is attachable to the bottle neck, in that the cap has at least one funnel-shaped cap feature, its feature interior space accommodating at least the free end region of the corresponding bottle feature, and in that the intermediate space between the end wall of the at least one bottle feature and the opposing side of the corresponding cap feature is completely filled by a hat-shaped sealing element which encloses the bottle feature at least in its end region facing away from the storage or infusion bottle and which is held at the circumference of its hat shape in a form-fitting and/or force-fitting manner on the circumference of the bottle feature.

The storage bottle according to the invention has a bottle neck moulded integrally thereon. At least one bottle feature, which is teat-shaped and is thus smaller than the cross section of the mouth end of the bottle neck, projects from the mouth end of the bottle neck, the closed teat end wall of said bottle feature being designed to be puncturable by an infusion needle. A cap, onto which the usual infusion equipment or similar extraction equipment is mountable, is attachable to the bottle neck. This cap has at least one funnel-shaped cap feature, its feature interior space accommodating at least the free end region of the corresponding bottle feature. A hat-shaped sealing element completely fills the intermediate space between the end wall of the at least one bottle feature and the opposing side of the corresponding cap feature, said sealing element enclosing the bottle feature at least in its end region facing away from the storage or infusion bottle. This sealing element is held at the circumference of its hat shape in a form-fitting and/or force-fitting manner on the circumference of the bottle feature. Since the sealing element completely fills the intermediate space between the end wall of the bottle neck feature and the opposing side of the corresponding cap feature, an intermediate space is avoided. Since the content of the bottle is extracted via the teat-shaped bottle feature, since this bottle feature has a smaller diameter or cross section as compared to the end wall, which forms the base, of the bottle neck, and since during piercing of the end wall of the bottle feature this end wall, which is relatively small in cross section, is less prone to distortion, the forming of an undesirable dead space is also not to be expected during piercing by the infusion needle. Since the sealing element with its hat shape encloses the bottle feature at least in its end region facing away from the storage or infusion bottle and is held at its internal circumference in a form-fitting or force-fitting manner on the circumference of the bottle feature, it is also not possible for a relatively large amount of leaking fluid to run out from the bottle opening punctured by means of the infusion needle. In this way, in the case of the bottle according to the invention, an at least substantially complete extraction of the fluid stored therein and thus also a correct dosing can be ensured.

In order to be able to mount the required infusion needle on the storage bottle according to the invention and to nevertheless be able, for instance, to add another active ingredient to the stored fluid, it is expedient that at least two bottle features project from the bottle neck and that each of these bottle features is accommodated by a corresponding cap feature.

A preferred embodiment, in which the sealing element mounted on the at least one bottle feature effectively prevents the discharge of leaking fluid, provides that the hat-shaped sealing element/sealing elements is/are each held on the corresponding bottle feature by means of a latching connection.

It is, in this context, advantageous that every sealing element, on the interior circumference of its hat shape, or every bottle feature, on its circumference, has at least one latching projection which interacts with a corresponding latching groove on the respective other component.

The puncturing by means of an infusion needle is facilitated, and at the same time any damage of the storage bottle hazardous to the sterility of the bottle content is effectively prevented, if at least one cap feature has a puncture opening which is preferably closed by means of a tear-away or a tear-off cover element.

A preferred embodiment according to the invention which also ensures a simple assembly of the storage bottle according to the invention provides that the at least one hat-shaped sealing element is held by means of bonding in the at least one cap feature.

Further developments according to the invention will emerge from the following description in conjunction with the claims and the drawing. In the following, the invention is explained in even more detail with reference to a preferred exemplary embodiment.

Shown on varying scales:

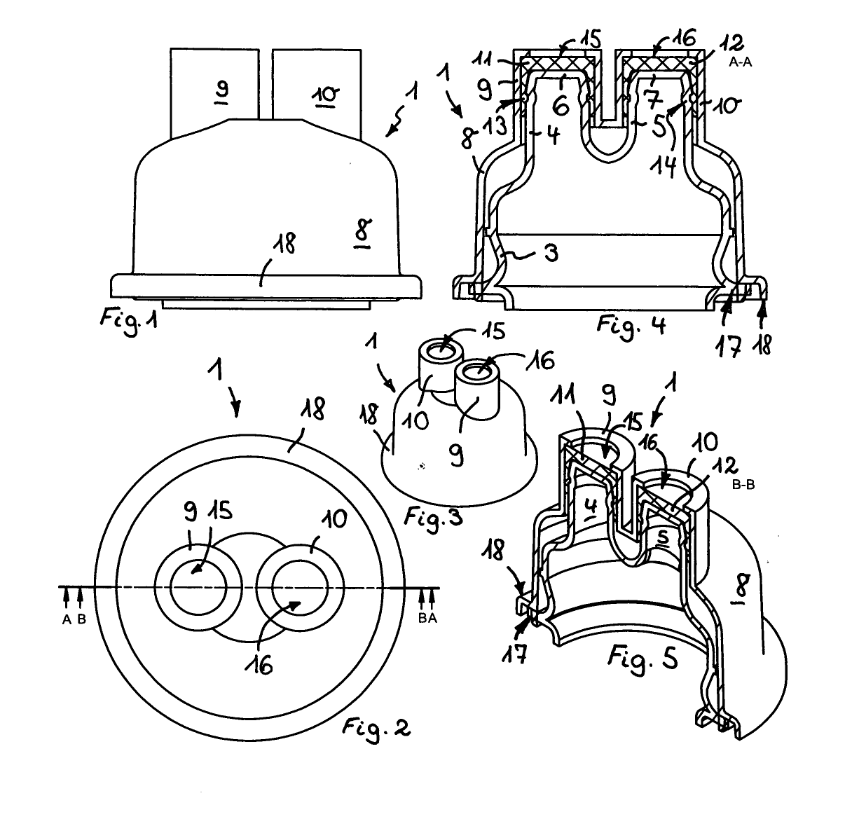

FIG. 1 is a lateral view of a storage bottle in the region of its bottle neck which bears a cap,

FIG. 2 is a plan view of the storage bottle according to FIG. 1, looking onto the cap located on the bottle neck of said bottle,

FIG. 3 is a perspective lateral view of the storage bottle according to FIGS. 1 and 2,

FIG. 4 is a longitudinal section of the storage bottle according to FIGS. 1 to 3 along the plane A-A according to FIG. 2, and

FIG. 5 is a perspective longitudinal section of the storage bottle according to FIGS. 1 to 4 along the plane B-B according to FIG. 2.

FIGS. 1 to 5 illustrate a storage or infusion bottle 1 in the region of its bottle neck 3 which bears a cap 8. The storage bottle 1 herein is embodied as a so-called blow-fill-seal bottle, in which the content of the bottle is enclosed in a sealed and sterile manner on all sides by the one-piece walling of the bottle. The storage bottle 1 thus also has a closed bottle walling at the end wall of its bottle neck 3. At least one bottle feature 4, 5 which is teat-shaped and thus smaller than the cross section of the mouth end of the bottle neck projects from the mouth end of bottle neck teat 3, the closed teat end wall of said bottle feature being designed to be puncturable by an infusion needle. A cap 8 is attachable to the bottle neck 3, onto which cap the usual infusion equipment or similar extraction equipment is mountable. This cap 8 has at least one funnel-shaped cap feature 9, 10, its feature interior space accommodating at least the free end region of the corresponding bottle feature 4, 5. A hat-shaped sealing element 11, 12 completely fills the intermediate space between the end wall 6, 7 of the at least one bottle feature 4, 5 and the opposing side of the corresponding cap feature 9, 10, said sealing element enclosing the bottle feature 4, 5 at least in its end region facing away from the storage bottle 1. This sealing element 11, 12 is held at the circumference of its hat shape in a form-fitting and/or force-fitting manner on the circumference of the bottle feature 4, 5. Since the sealing element 11, 12 completely fills the intermediate space between the end wall of the bottle feature 4, 5 and the opposing side of the corresponding cap feature 9, 10, an intermediate space is avoided.

It is clearly evident in the longitudinal sections according to FIGS. 4 and 5 that the storage bottle 1 herein has two teat-shaped bottle features 4, 5 on the mouth end of its bottle neck 3. Each of these bottle features 4, 5 projects into a funnel-shaped cap feature 9, 10. Here, in each case one hat-shaped sealing element is provided and preferably held by bonding in every cap feature 9, 10, said sealing element 11, 12 densely enclosing the corresponding bottle feature 4, 5 such that the intermediate space between the cap feature 9, 10 and the bottle feature 4, 5 is completely filled and free of dead space.

Since the bottle content is extracted via the teat-shaped bottle feature 4, 5, since the bottle feature 4, 5 has a smaller diameter or cross section as compared to the end wall, which forms the base, of the bottle neck 3, and since during piercing of the end wall of the bottle feature 4, 5 this end wall, which is relatively small in cross section, is less prone to distortion, the forming of an undesirable dead space is also not to be expected during piercing by the infusion needle. Since the sealing element 11, 12 with its hat shape encloses the bottle feature 4, 5 at least in its end region facing away from the storage or infusion bottle 1 and is held at its internal circumference in a form-fitting and/or force-fitting manner on the circumference of the bottle feature 4, 5, it is also not possible for a relatively large amount of leaking fluid to run out from the bottle opening punctured by means of the infusion needle. In this way, in the case of the storage bottle 1 illustrated here, a complete extraction of the fluid stored therein and thus a correct dosing can be ensured.

It is well recognizable in FIG. 4 that the hat-shaped sealing elements 11, 12 herein are each held on the corresponding bottle feature 4, 5 by means of a latching connection. For this purpose, every sealing element 11, 12 has on the interior circumference of its hat shape a latching projection 13 which interacts with a corresponding latching groove 14 on the outer circumference of the corresponding bottle feature 4, 5.

A comparison between the FIGS. 2, 3 and 5 elucidates that each of the funnel-shaped cap features 9, 10 has a puncture opening 15, 16. Not shown here is that these puncture openings 15, 16 may each be closed by a tear-away or tear-off cover element.

A comparison between the FIGS. 4 and 5 shows that an annular flange 17 projects from the bottle neck 3 of the storage bottle 1. The cap 8, which herein is approximately dome-shaped, is attachable to the bottle neck 3 of the storage bottle 1 to the point at which the margin of the cap circumference 18, which here is folded around in the shape of an edge of a plate, lies on the annular flange 17. In order to captively connect the cap with the storage bottle 1, the margin of the cap circumference 18 may be non-detachably connected to the annular flange 17 by means of welding or suchlike.

### LIST OF REFERENCE SIGNS

1 Storage bottle
3 Bottle neck
4 Bottle feature
5 Bottle feature
6 Teat end wall (of the bottle feature 4)
7 Teat end wall (of the bottle feature 5)
8 Cap
9 Cap feature
10 Cap feature
11 Sealing element
12 Sealing element
13 Latching projection
14 Latching groove
15 Puncture opening
16 Puncture opening
17 Annular flange
18 Margin of cap circumference

1. Storage or infusion bottle (1) with a bottle neck (3) moulded integrally thereon, the bottle neck having at least one teat-shaped bottle feature (4, 5) projecting from its mouth end, the closed teat end wall (6, 7) of said bottle feature being designed to be puncturable by an infusion needle, characterized in that a cap (8) is attachable to the bottle neck (3), in that the cap (8) has at least one funnel-shaped cap feature (9, 10), its (9, 10) feature interior space accommodating at least the free end region of the corresponding bottle feature (4, 5), and in that the intermediate space between the end wall of the at least one bottle feature (4, 5) and the opposing side of the corresponding cap feature (9, 10) is completely filled by a hat-shaped sealing element (11, 12) which encloses the bottle feature (4, 5) at least in its end region facing away from the storage or infusion bottle (1) and which is held at the circumference of its hat shape in a form-fitting and/or force-fitting manner on-the circumference of the bottle feature (4, 5).

2. Storage bottle according to claim 1, characterized in that at least two bottle features (4, 5) project from the bottle neck (3) and in that each of these bottle features (4, 5) is accommodated by a corresponding cap feature (9, 10).

3. Storage bottle according to claim 1, characterized in that the hat-shaped sealing element/sealing elements (1, 12) is/are each held on the corresponding bottle feature (4, 5) by means of a latching connection.

4. Storage bottle according to claim 1, characterized in that every sealing element (11, 12), on the interior circumference of its hat shape, or every bottle feature, on its circumference, has at least one latching projection (13) which interacts with a corresponding latching groove (14) on the respective other component.

5. Storage bottle according to claim 1, characterized in that at least one cap feature has a puncture opening (15, 16) which is preferably closed by means of a tear-away or a tear-off cover element.

6. Storage bottle according to claim 1, characterized in that the at least one hat-shaped sealing element (11, 12) is held by means of bonding in the at least one cap feature (9, 10).
